(19) United States
(12) Patent Application Publication
(10) Pub. No.: US 2011/0215898 A1
(43) Pub. Date: Sep. 8, 2011

(54) LOCKING SYSTEM

(75) Inventors: Rafael-Guillermo Ramos-Elizondo, Monterrey (MX); Jose-Adalberto Terán-Matus, San Pedro Garza Garcia (MX); Antonio Vidaurri-Ojeda, Monterrey (MX); Carlos Albores-Borja, Guadalupe Nuevo Leon (MX)

(73) Assignee: RFID MEXICO, S.A. de C.V., San Pedro Garza Garcia (MX)

(21) Appl. No.: 12/718,767

(22) Filed: Mar. 5, 2010

(51) Int. Cl. G06F 7/04

(52) U.S. Cl. 340/5.2

(57) ABSTRACT

An electronic locking system in which the control computer and a plurality of locking devices are connected by a data bus, and in which the communication between the external computers and each locking device is carried out by element of commands sent through the data bus.

### BACKGROUND OF THE INVENTION

A. Field of the Invention.

The present invention is related to electronic locking systems for locking and unlocking access means such as doors, drawers, etc. and more particularly to an electronic locking system in which the control computer and a plurality of locking devices are connected by means of a data bus, and in which the communication between said external computers and each locking device is carried out by means of commands sent trough said data bus.

B. Description of the Related Art.

Typically a system with multiple locking devices requires a master controller to issue an electrical signal through a dedicated line for each locking device installed to lock/unlock a plurality of accessing means such as doors or drawers. Additionally if there is a sensor to detect the position of the door/drawer, it must be read directly in a second line, usually as a voltage level. If a compartment has additional sensors and indicators (i.e. status lights) more additional lines must be employed and channeled to the control system. When a control system with multiple compartments must control several lines per compartment and several compartments, the driving lines quickly add up, which makes the complexity of the cabling and controlling system very high and costs go up.

In view of the above referred problems, applicant developed a system that requires only a 4 line data bus (dual channel RS-485) to control multiple locking devices. Said bus has added benefits due to its design since it is able to function over long distances and has a high noise tolerance, giving the ability to have the external computer and the locking devices in a different room or at long distances (more than 300 feet should be possible).

An additional data channel is provided in the same bus that allows data to be channeled from extra sensors or to indicators in the door or drawer.

Reducing the amount of cabling and the amount of driving lines is a very important step to reducing costs and complexity. This in turn also improves reliability and reusability of the entire locking system.

### SUMMARY OF THE INVENTION

It is therefore a main object of the present invention to provide a locking system including a plurality of locking devices for locking a plurality of access means such as doors or drawers which requires only a 4 line data bus (dual channel RS-485) to control said plurality of locking devices.

It is another main object of the present invention to provide a locking system of the above referred nature in which the data bus is able to function over long distances and has a high noise tolerance.

It is an additional object of the present invention to provide a locking system of the above referred nature in which an additional data channel is provided in the same bus that allows data to be channeled from extra sensors or to indicators in the door or drawer.

It is a further object of the present invention to provide a locking system of the above referred nature in which the amount of cabling and the amount of driving lines and the complexity of the system is reduced thanks to the use of the 4 line data bus.

These and other objects and advantages of the locking system of the present invention will become apparent to those persons having an ordinary skill in the art, from the following detailed description of the embodiments of the invention which will be made with reference to the accompanying drawings.

### BRIEF DESCRIPTION OF THE DRAWINGS

FIG. 1 is a scheme of a locking device of the locking system of the present invention.

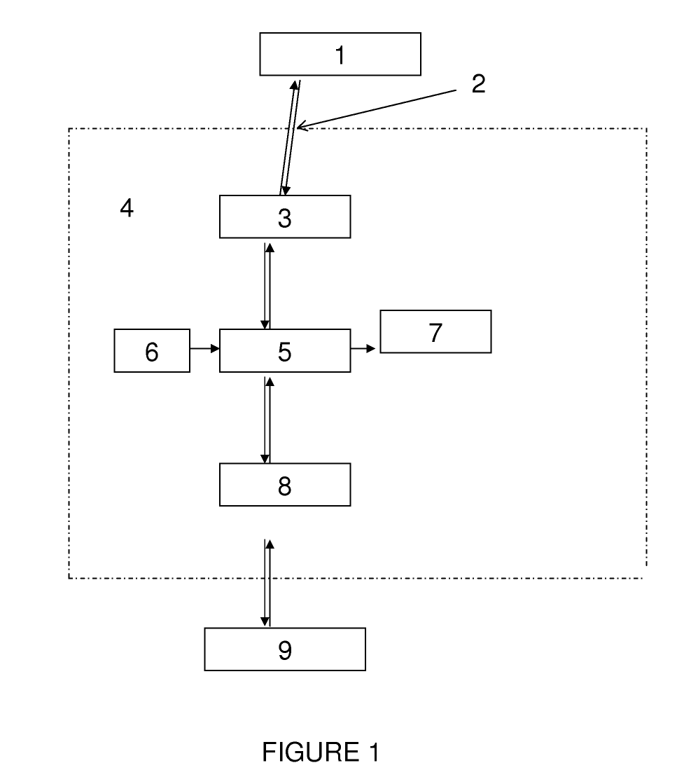

FIG. 2 is a scheme of the locking system of the present invention installed in a toolbox having a plurality of drawers.

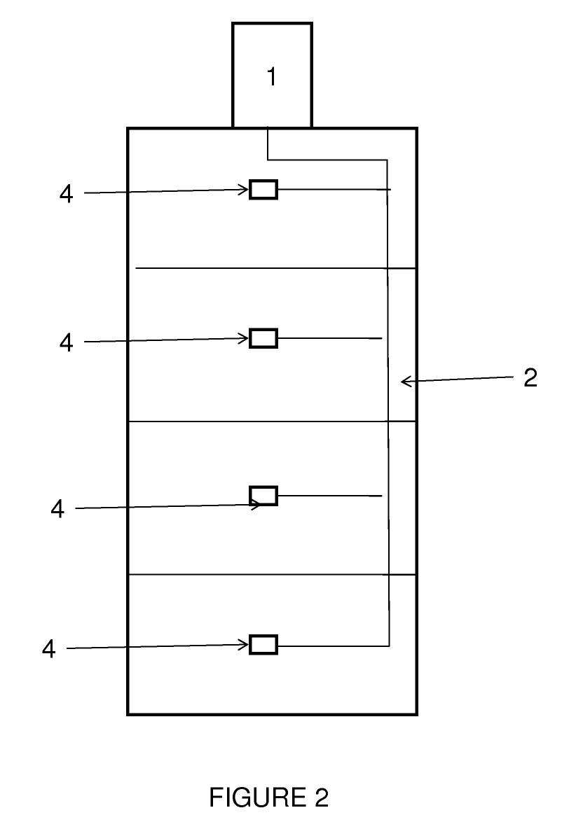

### DETAILED DESCRIPTION OF THE INVENTION

The locking system of the present invention will be described making reference to the accompanying drawings in which the same signs and numbers refer to a the same parts of the locking system.

In a preferred embodiment, the locking system is installed to a toolbox having a plurality of drawers, compartments or containers that require having locking means in order to secure its contents. The locking system of the present invention comprising
an external computer 1;
a four line data bus 2 connected to the external computer, comprising a dual channel RS-485 including an additional data channel;
a plurality of locking devices 4, each connected to the bus and each comprising:
   an external bus port 3 connected to the four line data bus;
   an electronic board 5 connected to the external bus port 3;
   a sensor 6 for each access means, for sensing via magnetic, optical, mechanical or other means the position of the compartment, door or drawer, such as if the compartment door or drawer is open or closed, wherein the sensor is connected to the electronic board;
   locking means 7, for locking or unlocking said compartment when it is given an input, which may comprise a solenoid, a motor/actuator, or a servo device, said locking means connected to the electronic board;
   a locking device frame/enclosure (not shown), for holding the electronic board, locking means and sensor in a steady position for optimal performance.
   wherein the electronic board 5 controls the locking means 7 for locking a compartment, door or drawer (not shown), handles bus communication with the external computer 1, receives the sensor 6 output which is sent to the external computer 1, and provides an extra data channel to act as a bridge for the communication between each locking device with the external computer 1, it further receives instructions from the external computer 1 through the four channel bus 2 and external bus port 3, for processing and responding to commands such like “lock all devices”, “unlock all devices”, “report status all devices”, “report id all devices”.

The electronic board 5 of each locking device 4 includes memory means (not shown), which stores a unique id number, which identifies each locking device 4 and allows the external computer to direct instructions to specific locking devices 4.

The electronic board 5 of each locking device 4 receives information from its respective sensor 6 related to the status of each drawer or container such as “locking device locked” or “locking device unlocked” or “drawer opened” or “drawer closed” and send said information to the external computer 1 trough the external bus port 3 and the four line data bus 2.

Furthermore, the electronic board 5 handles the locking means in accordance with its characteristics; this is configurable and depends on the electromechanical characteristics of the locking means. For example, some mechanisms require a pulse of a determined time to change the locking position, other mechanisms require a constant enabling to maintain a locked position (i.e. a 12 v signal output to lock, 0 v to unlock).

The external computer 1 receives said information and sends a specific command to the plurality of locking devices 4 or to a specific locking device 4 trough the four line data bus 2 and external bus port 3 in order to lock or unlock respective drawers or containers.

The commands sent by the computer 1 and processed by each locking device 4 are divided in macro commands, which are sent to the plurality of locking devices 4 and single device commands, which are sent to a specific locking devices 4 which, allows the external computer 1 to control or ask for the status from a specific locking device 4.

The single device commands sent trough the data bus 2 contains the id number of the locking device 4 to which is directed so that the command is processed by the correct intelligent locking device.

The Macro Commands, which are sent by the computer 1 and processed by all locking devices, are:
Lock all devices: causes all locking devices connected to the bus, to change their status to a locking position and locking its respective compartment if their respective compartments are closed, if not they will stay monitoring the sensor status and lock as soon as the compartment is closed. They can lock simultaneously or in sequence (with a small delay calculated with their id number) in order to minimize the instant power requirement to the power source.
Unlock all devices: causes all locking devices connected to the bus to change their status to an unlocked position and unlocking its respective compartment. They can unlock simultaneously or in sequence (with a small delay calculated with their id number) in order to minimize the instant power requirement to the power source.
Report status all devices: causes all locking devices connected to a bus to send their sensor status in sequence with a delay calculated with their id number to eliminate collisions in the bus.
Report ID all devices: causes all locking devices connected to a bus to send their ID in sequence with a delay calculated with the id number to eliminate collisions in the bus. This allows for an automatic discovery of all available and working locking devices in the bus.

The Single device commands which are sent by the computer 1 and processed by a specific locking device have a specific id number (#id), to which is specifically directed, said commands are:
Lock device #id: causes a specific locking device having a specific identification number, to change its status to a locked position and locking the respective compartment if the compartment is closed, if not the locking device will continue to monitor the sensor status and will change its status to a locked position as soon as the compartment is closed.
Unlock device #id: causes a specific locking device having a specific Id number to change its status to an unlocked position and locking the correspondent compartment.
Device status #id: causes a specific locking device to report the sensor status.

The electronic board 5 of each locking device 4 provides functionality to lock the compartment if communication is lost with the external computer, this happens when the external computer communication is lost (no commands for a determined period), as soon as the compartment is closed (if the compartment was closed at the moment of lost of communication, it will close automatically).

The electronic board 5 has an extra bidirectional data channel, which allows it to act as a bridge by using a bridge port 8, which is connected to the electronic board 5 for communication between other devices 9, installed in the compartments and the external computer.

Finally it must be understood that the locking system of the present invention, is not limited exclusively to the embodiment above described and illustrated and that the persons having ordinary skill in the art can, with the teaching provided by the invention, to make modifications to the locking system of the present invention, which will clearly be within of the true inventive concept and of the scope of the invention which is claimed in the following claims.

What is claimed is:

1. A locking system including more than one locking device for locking and unlocking a correspondent more than one accessing means, said locking system comprising:
an external computer;
a data bus connected to the external computer, including an additional data channel;
a plurality of locking devices for each access means, each connected to the bus and each comprising:
an external bus port connected to the data bus;
an electronic board 5 connected to the external bus port 3;
more than one locking means, for locking or unlocking said access means when it is given an input, said locking means connected to the electronic board;
a sensor for each access means, for sensing if the correspondent access means is open or closed and if the locking means are locked or unlocked, wherein the sensor is connected to the electronic board;
wherein the electronic board controls each locking means for locking or unlocking a correspondent access means, handles bus communication with the external computer, receives the sensor output which is sent to the external computer, and provides an extra data channel to act as a bridge for the communication between each locking device with the external computer, it further receives instructions from the external computer through the four channel bus and

2. A locking system as claimed in claim 1, wherein the data bus is a four line data bus comprising a dual channel RS-485.

3. A locking system as claimed in claim 1, wherein the locking means are selected from the group comprising a solenoid, a motor, an actuator, or a servo device.

4. A locking system as claimed in claim 1, wherein the electronic board, locking means and sensor of the locking device are contained inside a frame for holding said components in a steady position.

5. A locking system as claimed in claim 1, wherein the electronic board has an extra bidirectional data channel, which allows it to act as a bridge by using a bridge port, which is connected to the electronic board of each locking device for communicating other devices with the external computer.

6. A locking system as claimed in claim, wherein the commands sent by the computer and processed by each locking device are divided in macro commands, which are sent to the plurality of locking devices and single device commands, which are sent to a specific locking devices, which allows the external computer to control or ask for the status from a specific locking device.

7. A method for controlling at least one locking device for locking and unlocking a correspondent accessing means, said method comprising:
providing an external computer;
providing a data bus connected to the external computer;
providing at least one locking device for each access means, each controlled by electronic means, said electronic means connected to the data bus and having a sensor to detect if the correspondent access means is locked or closed and if the locking device is locked or unlocked;
sending commands to each locking device by the computer trough said data bus for controlling said locking device and said locking device responding to the commands received from the external computer.

8. A method as claimed in claim 7, wherein the data bus comprising a four line data bus.

9. A method as claimed in claim 7, further comprising providing an extra data channel for bidirectional data channel, which allows it to act as a bridge by using a bridge port, which is connected to the electronic means of each locking device for communicating other devices with external computer.

10. A method as claimed in clam 7, further comprising sending macro commands, to the plurality of locking devices.

11. A method as claimed in clam 7, further comprising sending single device commands to specific locking devices, which allows the external computer to control or ask for the status from a specific locking device.

12. A method as claimed in claim 7, further comprising sending macro commands, to the plurality of locking devices, said macro commands selected from the group comprising:
lock all devices: causes all locking devices connected to the bus, to change their status to a locking position and locking its correspondent access means if their respective access means are closed, if not they will stay monitoring the sensor status and lock as soon as the compartment is closed, wherein said locking devices can be locked simultaneously or in sequence in order to minimize the instant power requirement to a power source.
unlock all devices: causes all locking devices connected to the bus to change their status to an unlocked position and unlock its respective access means, which can be unlocked simultaneously or in sequence in order to minimize the instant power requirement to a power source.
report status all devices: causes all locking devices connected to the bus to send their sensor status in sequence with a delay calculated with an id number to eliminate collisions in the bus.
report ID all devices: causes all locking devices connected to a bus to send their ID in sequence with a delay calculated with the id number to eliminate collisions in the bus.

13. A method as claimed in claim 7, further comprising sending single device commands to specific locking devices, which allows the external computer to control or ask for the status from a specific locking device, said single device commands selected from the group comprising:
lock device #id: causes a specific locking device having a specific identification number, to change its status to a locked position and locking the access means if the access means is closed, if not the locking device will continue to monitor the sensor status and will change its status to a locked position as soon as the access means is closed.
unlock device #id: causes a specific locking device having a specific Id number to change its status to an unlocked position and locking the access means;
device status #id: causes a specific locking device to report the sensor status, said status information comprising the following information: “locking device locked” or “locking device unlocked” or “access means opened” or “access means closed”

14. A method as claimed in claim 7, further comprising the electronic means of each locking means changing its status to a locked position and locking the correspondent access means if communication is lost with the external computer as soon as the sensor detects that the access means is closed.
